(19) United States
(12) Patent Application Publication
(10) Pub. No.: US 2022/0389284 A1
(43) Pub. Date: Dec. 8, 2022

(54) DOUBLE-SIDED ADHESIVE TAPE

(71) Applicant: NITTO DENKO CORPORATION, Osaka (JP)

(72) Inventors: Toru ISEKI, Ibaraki-shi (JP); Masahito NIWA, Ibaraki-shi (JP); Junji FUKUHARA, Ibaraki-shi (JP); Ryosuke YOKOKAWA, Ibaraki-shi (JP)

(73) Assignee: NITTO DENKO CORPORATION, Osaka (JP)

(21) Appl. No.: 17/770,145

(22) PCT Filed: Aug. 20, 2020
(86) PCT No.: PCT/JP2020/031370

§ 371 Date: Apr. 19, 2022

(30) Foreign Application Priority Data
Nov. 20, 2019 (JP) 2019-209609

(51) Int. Cl. C09J 7/38

(52) U.S. Cl. CPC C09J 7/385; C09J 2203/326; C09J 2301/124; C09J 2301/302; C09J 2433/00

(57) ABSTRACT

Provided is a double-sided pressure-sensitive adhesive tape excellent in reworkability. A double-sided pressure-sensitive adhesive tape according to an embodiment of the present invention includes an acrylic pressure-sensitive adhesive, wherein the acrylic pressure-sensitive adhesive is formed from an acrylic pressure-sensitive adhesive composition, wherein the double-sided pressure-sensitive adhesive tape has a load at an elongation of 100% of 7 N/10 mm or less, and wherein the double-sided pressure-sensitive adhesive tape has a load at an elongation of 500% of 20 N/10 mm or less.

### TECHNICAL FIELD

The present invention relates to a double-sided pressure-sensitive adhesive tape.

### BACKGROUND ART

Expensive precision parts may be adopted as various constituent parts, such as an optical member and an electronic member, adopted in an optical device and an electronic device such as a mobile device. A double-sided pressure-sensitive adhesive tape may be adopted for bonding such precision parts (e.g., Patent Literature 1).

However, the precision parts are often brittle. Accordingly, when such bonded precision part needs to be peeled for replacement, for example, at the time of a process failure, the precision part may be broken at the time of the peeling, and hence there occurs a problem in that rework cannot be performed.

### CITATION LIST

### Patent Literature

[PTL 1] JP 2019-147851 A

### SUMMARY OF INVENTION

### Technical Problem

An object of the present invention is to provide a double-sided pressure-sensitive adhesive tape excellent in reworkability.

### Solution to Problem

According to one embodiment of the present invention, there is provided a double-sided pressure-sensitive adhesive tape, including an acrylic pressure-sensitive adhesive,

wherein the acrylic pressure-sensitive adhesive is formed from an acrylic pressure-sensitive adhesive composition,

wherein the double-sided pressure-sensitive adhesive tape has a load at an elongation of 100% of 7 N/10 mm or less, and

wherein the double-sided pressure-sensitive adhesive tape has a load at an elongation of 500% of 20 N/10 mm or less.

In one embodiment, the double-sided pressure-sensitive adhesive tape according to the embodiment of the present invention has a load at break of 15 N/10 mm or more.

In one embodiment, the double-sided pressure-sensitive adhesive tape according to the embodiment of the present invention has an elongation at break of 650% or more.

In one embodiment, the acrylic pressure-sensitive adhesive composition contains an acrylic oligomer.

In one embodiment, the acrylic pressure-sensitive adhesive composition contains a filler.

The double-sided pressure-sensitive adhesive tape according to the embodiment of the present invention is used for an electronic device.

### Advantageous Effects of Invention

According to the present invention, the double-sided pressure-sensitive adhesive tape excellent in reworkability can be provided.

### DESCRIPTION OF EMBODIMENTS

As used herein, the term “(meth)acryl” means at least one kind selected from an acryl and a methacryl, and the term “(meth)acrylate” means at least one kind selected from an acrylate and a methacrylate.

The term “acrylic polymer” as used herein refers to a polymerized product containing, as a monomer unit for forming the acrylic polymer, a monomer unit derived from a monomer having at least one (meth)acryloyl group in a molecule thereof. The term “acrylic oligomer” as used herein refers to a polymerized product containing, as a monomer unit for forming the acrylic oligomer, a monomer unit derived from a monomer having at least one (meth)acryloyl group in a molecule thereof. In addition, a monomer having at least one (meth)acryloyl group in a molecule thereof is referred to as “acrylic monomer.” The acrylic polymer as used herein is defined as a polymer containing a monomer unit derived from an acrylic monomer. The acrylic oligomer as used herein is defined as an oligomer containing a monomer unit derived from an acrylic monomer.

The term “polymerizable monomer” as used herein refers to a monomer having at least one polymerizable unsaturated double bond in a molecule thereof.

The Tg of a polymer as used herein refers to a nominal value described in, for example, a literature or a catalog, or a Tg (also referred to as “calculated Tg”) determined by Fox's equation on the basis of the composition of a monomer component to be used in the preparation of the polymer. As described below, Fox's equation is a relational equation between the Tg of a copolymer and the glass transition temperature Tgi of a homopolymer obtained by the homopolymerization of each of monomers for forming the copolymer.

1/Tg=Σ(Wi/Tgi)

In Fox's equation described above, Tg represents the glass transition temperature (unit: K) of the copolymer, Wi represents the weight fraction (copolymerization ratio on a weight basis) of a monomer “i” in the copolymer, and Tgi represents the glass transition temperature (unit: K) of the homopolymer of the monomer “i”. When a polymer of interest whose Tg is to be identified is a homopolymer, the Tg of the homopolymer and the Tg of the polymer of interest coincide with each other.

A value described in a known material is used as the glass transition temperature of the homopolymer to be used in the calculation of the Tg. Specifically, numerical values are listed in “Polymer Handbook” (3rd edition, John Wiley & Sons, Inc., 1989). With regard to a monomer for which a plurality of kinds of values are described in the above-mentioned “Polymer Handbook,” the highest value is adopted.

With regard to such a monomer that the glass transition temperature of its homopolymer is not described in the above-mentioned literature “Polymer Handbook,” a value obtained by the following measurement method is used. Specifically, 100 parts by weight of the monomer, 0.2 part by weight of 2,2′-azobisisobutyronitrile, and 200 parts by weight of ethyl acetate serving as a polymerization solvent are loaded into a reaction vessel including a temperature gauge, a stirring machine, a nitrogen-introducing tube, and a reflux condenser, and are stirred for 1 hour while a nitrogen gas is flowed in the vessel. After oxygen in the polymerization system has been removed as described above, the temperature of the mixture is increased to 63° C. and the mixture is subjected to a reaction for 10 hours. Next, the resultant is cooled to room temperature to provide a homopolymer solution having a solid content concentration of 33 wt %. Next, the homopolymer solution is applied onto a release liner by cast coating, and is dried to produce a test sample (sheet-shaped homopolymer) having a thickness of about 2 mm. The test sample is punched into a disc shape having a diameter of 7.9 mm, and is sandwiched between parallel plates, followed by the measurement of its viscoelasticity with a viscoelasticity tester (manufactured by TA Instruments Japan Inc., model name: “ARES”) in the temperature region of from −70° C. to 150° C. at a rate of temperature increase of 5° C./min by a shear mode while shear strain having a frequency of 1 Hz is applied thereto. A temperature corresponding to the peak top temperature of the viscoelasticity tan δ is defined as the Tg of the homopolymer.

### <<<<Double-sided Pressure-sensitive Adhesive Tape>>>>

A double-sided pressure-sensitive adhesive tape according to an embodiment of the present invention includes an acrylic pressure-sensitive adhesive. The double-sided pressure-sensitive adhesive tape according to the embodiment of the present invention may include any appropriate other layer to such an extent that the effect of the present invention is not impaired as long as the tape includes the acrylic pressure-sensitive adhesive.

The double-sided pressure-sensitive adhesive tape according to the embodiment of the present invention may include one layer of the acrylic pressure-sensitive adhesive, or may include two or more layers of the acrylic pressure-sensitive adhesive. The double-sided pressure-sensitive adhesive tape according to the embodiment of the present invention preferably includes one layer of the acrylic pressure-sensitive adhesive from the viewpoint of, for example, production cost.

The thickness of the double-sided pressure-sensitive adhesive tape according to the embodiment of the present invention is preferably from 20 μm to 900 μm, more preferably from 40 μm to 800 μm, still more preferably from 60 μm to 700 μm, particularly preferably from 80 μm to 600 μm, most preferably from 100 μm to 500 μm. When the thickness of the double-sided pressure-sensitive adhesive tape falls within the ranges, the double-sided pressure-sensitive adhesive tape according to the embodiment of the present invention becomes more excellent in reworkability.

In the double-sided pressure-sensitive adhesive tape according to the embodiment of the present invention, any appropriate release liner may be arranged on the surface of the acrylic pressure-sensitive adhesive for, for example, protecting the tape until the tape is used to such an extent that the effect of the present invention is not impaired. Examples of the release liner include: a release liner obtained by subjecting the surface of a base material (liner base material), such as paper or a plastic film, to silicone treatment; and a release liner obtained by laminating a polyolefin-based resin on the surface of a base material (liner base material), such as paper or a plastic film. Examples of the plastic film serving as the liner base material include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film. The plastic film serving as the liner base material is preferably a polyethylene film.

The thickness of the release liner is preferably from 1 μm to 500 μm, more preferably from 3 μm to 450 μm, still more preferably from 5 μm to 400 μm, particularly preferably from 10 μm to 300 μm.

The pressure-sensitive adhesive strength of the double-sided pressure-sensitive adhesive tape according to the embodiment of the present invention is preferably from 2 N/10 mm to 24 N/10 mm, more preferably from 4 N/10 mm to 22 N/10 mm, still more preferably from 6 N/10 mm to 20 N/10 mm, particularly preferably from 8 N/10 mm to 18 N/10 mm. When the pressure-sensitive adhesive strength of the double-sided pressure-sensitive adhesive tape of the present invention falls within the ranges, the tape can sufficiently express a function as a double-sided pressure-sensitive adhesive tape.

The pressure-sensitive adhesive strength may be typically measured as described below. One surface of a PET film is subjected to corona treatment, and the corona-treated surface is bonded to one surface of the double-sided pressure-sensitive adhesive tape. The bonded product is cut into a size measuring 10 mm wide by 100 mm long, and is pressure-bonded to a clean SUS304BA plate, which has been cleaned by being reciprocally rubbed 10 times with a clean waste cloth impregnated with isopropyl alcohol, by a method including reciprocally rolling a 2 kg roller once to provide a sample for an adhesive strength evaluation. The evaluation sample is left to stand under a measurement environment at 23° C. and 50% RH for 30 minutes, and then its pressure-sensitive adhesive strength [N/10 mm] may be measured with a tensile tester under the conditions of a tensile rate of 300 mm/min and a peel angle of 180°.

The load of the double-sided pressure-sensitive adhesive tape according to the embodiment of the present invention at an elongation of 100% is preferably 7 N/10 mm or less, more preferably from 0.1 N/10 mm to 6.8 N/10 mm, still more preferably from 0.5 N/10 mm to 6.6 N/10 mm, particularly preferably from 1 N/10 mm to 6.4 N/10 mm. When the load of the double-sided pressure-sensitive adhesive tape at an elongation of 100% falls within the ranges, the double-sided pressure-sensitive adhesive tape according to the embodiment of the present invention becomes more excellent in reworkability. Details about the measurement of the load at an elongation of 100% are described later.

The load of the double-sided pressure-sensitive adhesive tape according to the embodiment of the present invention at an elongation of 500% is preferably 20 N/10 mm or less, more preferably from 1 N/10 mm to 19 N/10 mm, still more preferably from 2 N/10 mm to 18 N/10 mm, particularly preferably from 3 N/10 mm to 17 N/10 mm. When the load of the double-sided pressure-sensitive adhesive tape at an elongation of 500% falls within the ranges, the double-sided pressure-sensitive adhesive tape according to the embodiment of the present invention becomes more excellent in reworkability. Details about the measurement of the load at an elongation of 500% are described later.

The load at break of the double-sided pressure-sensitive adhesive tape according to the embodiment of the present invention is preferably 15 N/10 mm or more, more preferably from 15.5 N/10 mm to 100 N/10 mm, still more preferably from 16 N/10 mm to 80 N/10 mm, particularly preferably from 17 N/10 mm to 60 N/10 mm. When the load at break of the double-sided pressure-sensitive adhesive tape falls within the ranges, the double-sided pressure-sensitive adhesive tape according to the embodiment of the present invention becomes more excellent in reworkability. Details about the measurement of the load at break are described later.

The elongation at break of the double-sided pressure-sensitive adhesive tape according to the embodiment of the present invention is preferably 650% or more, more preferably from 675% to 1,800%, still more preferably from 700% to 1,600%, particularly preferably from 725% to 1,400%. When the elongation at break of the double-sided pressure-sensitive adhesive tape falls within the ranges, the double-sided pressure-sensitive adhesive tape according to the embodiment of the present invention becomes more excellent in reworkability. Details about the measurement of the elongation at break are described later.

The double-sided pressure-sensitive adhesive tape according to the embodiment of the present invention may be used in various applications. The double-sided pressure-sensitive adhesive tape according to the embodiment of the present invention is typically used for an electronic device.

### <<Acrylic Pressure-Sensitive Adhesive Composition>>

The acrylic pressure-sensitive adhesive is formed from an acrylic pressure-sensitive adhesive composition.

The acrylic pressure-sensitive adhesive preferably contains a polymer component having a weight-average molecular weight of 1,000,000 or more at a solid content concentration of 10% or more, and the solid content concentration is more preferably from 40% to 80%, still more preferably from 45% to 75%, particularly preferably from 50% to 70%. When the content of the polymer component having a weight-average molecular weight of 1,000,000 or more in the acrylic pressure-sensitive adhesive falls within the ranges in terms of solid content concentration, the double-sided pressure-sensitive adhesive tape according to the embodiment of the present invention becomes more excellent in reworkability.

The acrylic pressure-sensitive adhesive is formed from the acrylic pressure-sensitive adhesive composition by any appropriate method. In the present invention, such method typically includes: applying the acrylic pressure-sensitive adhesive composition onto any appropriate base material; then mounting another appropriate base material on the surface of a pressure-sensitive adhesive layer formed by the application; and applying UV light to cure the layer, thereby forming the pressure-sensitive adhesive. The base material is, for example, the above-mentioned release liner. Any appropriate application method may be adopted as a method for the application of the acrylic pressure-sensitive adhesive composition to such an extent that the effect of the present invention is not impaired. Such application method is, for example, roll coating, kiss roll coating, gravure coating, reverse coating, roll brushing, spray coating, dip roll coating, bar coating, knife coating, air knife coating, curtain coating, lip coating, or extrusion coating using a die coater.

Heating may be performed at the time of the formation of the acrylic pressure-sensitive adhesive as required from the viewpoints of, for example, the acceleration of a cross-linking reaction and an improvement in production efficiency. In addition, aging may be performed for the purposes of, for example, adjusting the migration of a component in the formed acrylic pressure-sensitive adhesive, advancing the cross-linking reaction, and alleviating strain that may be present in the acrylic pressure-sensitive adhesive.

The acrylic pressure-sensitive adhesive composition contains an acrylic partially polymerized product obtained by polymerizing a monomer component (m1), a monomer component (m2), a cross-linking agent, and a photopolymerization initiator.

The acrylic pressure-sensitive adhesive composition may contain any appropriate other component to such an extent that the effect of the present invention is not impaired as long as the composition contains the acrylic partially polymerized product obtained by polymerizing the monomer component (m1), the monomer component (m2), the cross-linking agent, and the photopolymerization initiator.

When the monomer component (m1) and the monomer component (m2) are regarded as all monomer components, the calculated Tg of an acrylic polymer derived from all the monomer components, which is calculated as the weighted average of the Tgs of the monomer components, is typically −30° C. or less. When the monomer component (m1) and the monomer component (m2) are regarded as all the monomer components, and the calculated Tg of the acrylic polymer derived from all the monomer components, which is calculated as the weighted average of the Tgs of the monomer components, falls within the range, the double-sided pressure-sensitive adhesive tape according to the embodiment of the present invention becomes more excellent in reworkability.

### <Acrylic Partially Polymerized Product>

With regard to the content of the acrylic partially polymerized product in the acrylic pressure-sensitive adhesive composition, when the entirety of the acrylic pressure-sensitive adhesive composition is defined as 100 parts by weight, the content of the acrylic partially polymerized product is preferably from 20 parts by weight to 80 parts by weight, more preferably from 30 parts by weight to 70 parts by weight, still more preferably from 40 parts by weight to 70 parts by weight, particularly preferably from 50 parts by weight to 70 parts by weight. When the content of the acrylic partially polymerized product in the acrylic pressure-sensitive adhesive composition falls within the ranges, the double-sided pressure-sensitive adhesive tape according to the embodiment of the present invention becomes more excellent in reworkability.

The acrylic partially polymerized product is obtained by polymerizing the monomer component (m1).

The acrylic partially polymerized product is different from a product obtained as the completely polymerized product of the monomer component (m1) (preferably a polymerized product having a polymerization conversion rate of more than 95 wt %), and is preferably a partially polymerized product obtained by polymerizing the monomer component (m1) at a polymerization conversion rate of 95 wt % or less.

The polymerization conversion rate of the acrylic partially polymerized product is preferably 70 wt % or less, more preferably 60 wt % or less, still more preferably 50 wt % or less, particularly preferably 40 wt % or less, most preferably 35 wt % or less. The lower limit of the polymerization conversion rate of the acrylic partially polymerized product is preferably 1 wt % or more, more preferably 5 wt % or more.

The acrylic partially polymerized product may be preferably produced by active energy ray polymerization, such as UV polymerization or electron beam polymerization. The acrylic partially polymerized product may be more preferably produced by the UV polymerization.

Any appropriate UV polymerization method may be adopted as a method for the UV polymerization to such an extent that the effect of the present invention is not impaired. Such UV polymerization method is, for example, as follows: the monomer component (m1) is blended with the photopolymerization initiator, and as required, the polyfunctional (meth)acrylate, and the resultant is irradiated with UV light.

When the acrylic partially polymerized product is produced by polymerizing the monomer component (m1), a reaction product typically includes: the acrylic partially polymerized product obtained by polymerizing at least part of the monomer component (m1); and at least part of the monomer component (m1) (unreacted monomer remaining without being polymerized). That is, the reaction product includes part of the monomer component (m1) as a polymerized product, specifically the acrylic partially polymerized product, and includes the residue of the monomer component (m1) as the form of an unpolymerized product (unreacted monomer). Such reaction product typically shows a syrupy state (viscous liquid state), and is sometimes referred to as “monomer syrup” or simply “syrup”.

The monomer component (m1) preferably contains an alkyl (meth)acrylate having, at an ester terminal thereof, an alkyl group having 4 to 10 carbon atoms. The alkyl (meth)acrylates each having, at an ester terminal thereof, an alkyl group having 4 to 10 carbon atoms in the monomer component (m1) may be used alone or in combination thereof.

To distinguish the alkyl (meth)acrylate having, at an ester terminal thereof, an alkyl group having 4 to 10 carbon atoms as used herein from a “polymerizable monomer whose corresponding homopolymer has a Tg of 0° C. or more” to be described later, the Tg of its corresponding homopolymer is preferably less than 0° C.

Examples of the alkyl (meth)acrylate having, at an ester terminal thereof, an alkyl group having 4 to 10 carbon atoms that may be incorporated into the monomer component (m1) include n-butyl (meth)acrylate, n-pentyl (meth)acrylate, n-hexyl (meth)acrylate, n-heptyl (meth)acrylate, n-octyl (meth)acrylate, n-nonyl (meth)acrylate, n-decyl (meth)acrylate, t-butyl (meth)acrylate, isobutyl (meth)acrylate, isopentyl (meth)acrylate, t-pentyl (meth)acrylate, neopentyl (meth)acrylate, isohexyl (meth)acrylate, isoheptyl (meth)acrylate, 2-ethylhexyl (meth)acrylate, isooctyl (meth)acrylate, isononyl (meth)acrylate, isodecyl (meth)acrylate, and 2-propylheptyl (meth)acrylate. Of those, at least one kind selected from n-butyl (meth)acrylate and 2-ethylhexyl (meth)acrylate is preferred in terms of handleability and because the effect of the present invention can be further expressed, and 2-ethylhexyl (meth)acrylate is more preferred.

The content of the alkyl (meth)acrylate having, at an ester terminal thereof, an alkyl group having 4 to 10 carbon atoms in the monomer component (m1) is preferably from 30 wt % to 99 wt %, more preferably from 40 wt % to 95 wt %, still more preferably from 50 wt % to 90 wt %, particularly preferably from 60 wt % to 85 wt %, most preferably from 70 wt % to 80 wt %. When the content of the alkyl (meth)acrylate having, at an ester terminal thereof, an alkyl group having 4 to 10 carbon atoms in the monomer component (m1) falls within the ranges, the double-sided pressure-sensitive adhesive tape of the present invention can express more excellent reworkability.

The monomer component (m1) preferably contains a hydroxy group-containing monomer. The hydroxy group-containing monomers in the monomer component (m1) may be used alone or in combination thereof.

To distinguish the hydroxy group-containing monomer as used herein from a “polymerizable monomer whose corresponding homopolymer has a Tg of 0° C. or more” to be described later, the Tg of its corresponding homopolymer is preferably less than 0° C.

Specific examples of the hydroxy group-containing monomer that may be incorporated into the monomer component (m1) include: hydroxyalkyl (meth)acrylates, such as 2-hydroxybutyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate; hydroxyalkylcycloalkane (meth)acrylates such as (4-hydroxymethylcyclohexyl)methyl (meth)acrylate; and other hydroxy group-containing monomers, such as hydroxyethyl (meth)acrylamide, allyl alcohol, 2-hydroxyethyl vinyl ether, 4-hydroxybutyl vinyl ether, and diethylene glycol monovinyl ether. Of those, a hydroxyalkyl (meth)acrylate is preferred in terms of handleability and because the effect of the present invention can be further expressed, and a hydroxyalkyl (meth)acrylate having a hydroxyalkyl group having 2 to 6 carbon atoms is more preferred. Specifically, at least one kind selected from 2-hydroxyethyl (meth)acrylate and 4-hydroxybutyl (meth)acrylate is preferred, and 2-hydroxyethyl (meth)acrylate is more preferred.

The content of the hydroxy group-containing monomer in the monomer component (m1) is preferably from 0.1 wt % to 30 wt %, more preferably from 0.5 wt % to 20 wt %, still more preferably from 1 wt % to 10 wt %, particularly preferably from 2 wt % to 7 wt %. When the content of the hydroxy group-containing monomer in the monomer component (m1) falls within the ranges, the double-sided pressure-sensitive adhesive tape of the present invention can express more excellent reworkability.

The monomer component (m1) preferably contains a polymerizable monomer whose corresponding homopolymer has a Tg of 0° C. or more. The polymerizable monomers whose corresponding homopolymers each have a Tg of 0° C. or more in the monomer component (m1) may be used alone or in combination thereof.

Any appropriate polymerizable monomer whose corresponding homopolymer has a Tg of 0° C. or more may be adopted as the polymerizable monomer whose corresponding homopolymer has a Tg of 0° C. or more that may be incorporated into the monomer component (m1) to such an extent that the effect of the present invention is not impaired. Examples of such polymerizable monomer whose corresponding homopolymer has a Tg of 0° C. or more include acrylic acid, N-vinyl-2-pyrrolidone, dicyclopentanyl methacrylate, methyl methacrylate, cyclohexyl acrylate, isobornyl acrylate, β-carboxyethyl acrylate, 2-hydroxy-3-phenoxypropyl acrylate, acrylonitrile, acrylamide, dimethylacrylamide, isopropylacrylamide, hydroxyethylacrylamide, hydroxymethylacrylamide, hydroxybutylacrylamide, acryloylmorpholine, and 1-vinylimidazole. Of those, at least one kind selected from acrylic acid and N-vinyl-2-pyrrolidone is preferred because the effect of the present invention can be further expressed.

The content of the polymerizable monomer whose corresponding homopolymer has a Tg of 0° C. or more in the monomer component (m1) is preferably from 1 wt % to 50 wt %, more preferably from 5 wt % to 40 wt %, still more preferably from 8 wt % to 30 wt %, particularly preferably from 10 wt % to 25 wt %, most preferably from 15 wt % to 20 wt %. When the content of the polymerizable monomer whose corresponding homopolymer has a Tg of 0° C. or more in the monomer component (m1) falls within the ranges, the double-sided pressure-sensitive adhesive tape of the present invention can express more excellent reworkability.

The monomer component (m1) more preferably contains the alkyl (meth)acrylate having, at an ester terminal thereof, an alkyl group having 4 to 10 carbon atoms, the hydroxy group-containing monomer, and the polymerizable monomer whose corresponding homopolymer has a Tg of 0° C. or more. The above-mentioned description may be cited as it is for the alkyl (meth)acrylate having, at an ester terminal thereof, an alkyl group having 4 to 10 carbon atoms, the hydroxy group-containing monomer, and the polymerizable monomer whose corresponding homopolymer has a Tg of 0° C. or more in this case.

When the amount of all monomers in the monomer component (m1) is defined as 100 parts by weight, the total ratio of the alkyl (meth)acrylate having, at an ester terminal thereof, an alkyl group having 4 to 10 carbon atoms, the hydroxy group-containing monomer, and the polymerizable monomer whose corresponding homopolymer has a Tg of 0° C. or more in the monomer component (m1) is preferably from 50 parts by weight to 100 parts by weight, more preferably from 70 parts by weight to 100 parts by weight, still more preferably from 90 parts by weight to 100 parts by weight, still more preferably from 95 parts by weight to 100 parts by weight, particularly preferably from 98 parts by weight to 100 parts by weight, most preferably substantially 100 parts by weight because the effect of the present invention can be further expressed. The term “substantially 100 parts by weight” as used herein means that the monomer component (m1) is formed of the alkyl (meth)acrylate having, at an ester terminal thereof, an alkyl group having 4 to 10 carbon atoms, the hydroxy group-containing monomer, and the polymerizable monomer whose corresponding homopolymer has a Tg of 0° C. or more, but may contain a trace amount of any other component (typically an impurity, a by-product, or the like) to such an extent that the effect of the present invention is not impaired.

The monomer component (m1) may contain any appropriate other monomer to such an extent that the effect of the present invention is not impaired. Such other monomer is any appropriate monomer, which is a polymerizable monomer whose corresponding homopolymer has a Tg of less than 0° C., and is none of the alkyl (meth)acrylate having, at an ester terminal thereof, an alkyl group having 4 to 10 carbon atoms and the hydroxy group-containing monomer. Such other monomers may be used alone or in combination thereof.

Examples of the other monomer that may be incorporated into the monomer component (m1) include acryloyl group-modified compounds, such as an acryloyl group-containing silicone oil, epoxy acrylate, and urethane acrylate.

Any appropriate photopolymerization initiator may be adopted as the photopolymerization initiator that may be used when the acrylic partially polymerized product is produced by polymerizing the monomer component (m1) to such an extent that the effect of the present invention is not impaired. The photopolymerization initiators may be used alone or in combination thereof. Examples of such photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, and an acylphosphine oxide-based photopolymerization initiator.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (e.g., a commercial product available under the product name “OMNIRAD 651” from IGM Resins B.V.), and anisole methyl ether.

Specific examples of the acetophenone-based photopolymerization initiator include 1-hydroxycyclohexyl phenyl ketone (e.g., a commercial product available under the product name “OMNIRAD 184” from IGM Resins B.V.), 4-phenoxydichloroacetophenone, 4-t-butyl-dichloroacetophenone, 1-[4-(2-hydroxyethoxy)-phenyl]-2-hydroxy-2-methyl-1-propan-1-one (e.g., a commercial product available under the product name “OMNIRAD 2959” from IGM Resins B.V.), 2-hydroxy-2-methyl-1-phenyl-propan-1-one, and methoxyacetophenone.

Specific examples of the α-ketol-based photopolymerization initiator include 2-methyl-2-hydroxypropiophenone and 1-[4-(2-hydroxyethyl)-phenyl]-2-hydroxy-2-methylpropan-1-one.

A specific example of the aromatic sulfonyl chloride-based photopolymerization initiator is 2-naphthalenesulfonyl chloride.

A specific example of the photoactive oxime-based photopolymerization initiator is 1-phenyl-1,1-propanedione-2-(o-ethoxycarbonyl)-oxime.

A specific example of the benzoin-based photopolymerization initiator is benzoin.

A specific example of the benzil-based photopolymerization initiator is benzil.

Specific examples of the benzophenone-based photopolymerization initiator include benzophenone, benzoylbenzoic acid, 3,3′-dimethyl-4-methoxybenzophenone, polyvinylbenzophenone, and α-hydroxycyclohexyl phenyl ketone.

A specific example of the ketal-based photopolymerization initiator is benzyl dimethyl ketal.

Specific examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Specific examples of the acylphosphine-based photopolymerization initiator include bis(2,6-dimethoxybenzoyl)phenylphosphine oxide, bis(2,6-dimethoxybenzoyl) (2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl) (2-methylpropan-1-yl)phosphine oxide, bis(2-methoxybenzoyl) (1-methylpropan-1-yl)phosphine oxide, bis(2,6-diethoxybenzoyl) (2-methylpropan-1-yl)phosphine oxide, bis(2,6-diethoxybenzoyl) (1-methylpropan-1-yl)phosphine oxide, bis(2,6-dibutoxybenzoyl) (2-methylpropan-1-yl)phosphine oxide, bis(2,4-dimethoxybenzoyl) (2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoylbenzylbutylphosphine oxide, 2,6-dimethoxybenzoylbenzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

The usage amount of the photopolymerization initiator is preferably 5 parts by weight or less, more preferably from 0.01 part by weight to 5 parts by weight, still more preferably from 0.01 part by weight to 1 part by weight, particularly preferably from 0.01 part by weight to 0.5 part by weight, most preferably from 0.01 part by weight to 0.1 part by weight with respect to 100 parts by weight of the total amount of the monomer component (m1) from the viewpoint of, for example, the expression of satisfactory polymerizability.

<Monomer Component (m2)>

With regard to the content of the monomer component (m2) in the acrylic pressure-sensitive adhesive composition, when the entirety of the acrylic pressure-sensitive adhesive composition is defined as 100 parts by weight, the total content of the monomer component (m2) is preferably from 5 parts by weight to 50 parts by weight, more preferably from 10 parts by weight to 45 parts by weight, still more preferably from 15 parts by weight to 40 parts by weight, particularly preferably from 20 parts by weight to 35 parts by weight, most preferably from 25 parts by weight to 30 parts by weight. When the content of the monomer component (m2) in the acrylic pressure-sensitive adhesive composition falls within the ranges, the double-sided pressure-sensitive adhesive tape according to the embodiment of the present invention becomes more excellent in reworkability.

The monomer component (m2) typically contains the alkyl (meth)acrylate having, at an ester terminal thereof, an alkyl group having 4 to 10 carbon atoms, and the polymerizable monomer whose corresponding homopolymer has a Tg of 0° C. or more.

When the amount of all monomers in the monomer component (m2) is defined as 100 parts by weight, the total ratio of the alkyl (meth)acrylate having, at an ester terminal thereof, an alkyl group having 4 to 10 carbon atoms, and the polymerizable monomer whose corresponding homopolymer has a Tg of 0° C. or more in the monomer component (m2) is preferably from 50 parts by weight to 100 parts by weight, more preferably from 70 parts by weight to 100 parts by weight, still more preferably from 90 parts by weight to 100 parts by weight, still more preferably from 95 parts by weight to 100 parts by weight, particularly preferably from 98 parts by weight to 100 parts by weight, most preferably substantially 100 parts by weight because the effect of the present invention can be further expressed. The term “substantially 100 parts by weight” as used herein means that the monomer component (m2) is formed of the alkyl (meth)acrylate having, at an ester terminal thereof, an alkyl group having 4 to 10 carbon atoms, and the polymerizable monomer whose corresponding homopolymer has a Tg of 0° C. or more, but may contain a trace amount of any other component (typically an impurity, a by-product, or the like) to such an extent that the effect of the present invention is not impaired.

The monomer component (m2) may contain any appropriate other monomer to such an extent that the effect of the present invention is not impaired. Such other monomer is any appropriate monomer, which is a polymerizable monomer whose corresponding homopolymer has a Tg of less than 0° C., and is not the alkyl (meth)acrylate having, at an ester terminal thereof, an alkyl group having 4 to 10 carbon atoms. Such other monomers may be used alone or in combination thereof.

In the monomer component (m2), the content of the polymerizable monomer whose corresponding homopolymer has a Tg of 0° C. or more is typically from 10 parts by weight to 90 parts by weight, preferably from 12 parts by weight to 80 parts by weight, more preferably from 15 parts by weight to 70 parts by weight, still more preferably from 20 parts by weight to 65 parts by weight, particularly preferably from 25 parts by weight to 65 parts by weight, most preferably from 30 parts by weight to 60 parts by weight with respect to 100 parts by weight of the alkyl (meth)acrylate having, at an ester terminal thereof, an alkyl group having 4 to 10 carbon atoms. When the content of the polymerizable monomer whose corresponding homopolymer has a Tg of 0° C. or more with respect to 100 parts by weight of the alkyl (meth)acrylate having, at an ester terminal thereof, an alkyl group having 4 to 10 carbon atoms falls within the ranges, the double-sided pressure-sensitive adhesive tape according to the embodiment of the present invention becomes more excellent in reworkability.

The alkyl (meth)acrylates each having, at an ester terminal thereof, an alkyl group having 4 to 10 carbon atoms in the monomer component (m2) may be used alone or in combination thereof. To distinguish the alkyl (meth)acrylate having, at an ester terminal thereof, an alkyl group having 4 to 10 carbon atoms that may be incorporated into the monomer component (m2) from a “polymerizable monomer whose corresponding homopolymer has a Tg of 0° C. or more” to be described later, the Tg of its corresponding homopolymer is preferably less than 0° C.

Examples of the alkyl (meth)acrylate having, at an ester terminal thereof, an alkyl group having 4 to 10 carbon atoms that may be incorporated into the monomer component (m2) include n-butyl (meth)acrylate, n-pentyl (meth)acrylate, n-hexyl (meth)acrylate, n-heptyl (meth)acrylate, n-octyl (meth)acrylate, n-nonyl (meth)acrylate, n-decyl (meth)acrylate, t-butyl (meth)acrylate, isobutyl (meth)acrylate, isopentyl (meth)acrylate, t-pentyl (meth)acrylate, neopentyl (meth)acrylate, isohexyl (meth)acrylate, isoheptyl (meth)acrylate, 2-ethylhexyl (meth)acrylate, isooctyl (meth)acrylate, isononyl (meth)acrylate, isodecyl (meth)acrylate, and 2-propylheptyl (meth)acrylate. Of those, at least one kind selected from n-butyl (meth)acrylate and 2-ethylhexyl (meth)acrylate is preferred in terms of handleability and because the effect of the present invention can be further expressed, and 2-ethylhexyl (meth)acrylate is more preferred.

The content of the alkyl (meth)acrylate having, at an ester terminal thereof, an alkyl group having 4 to 10 carbon atoms in the monomer component (m2) is preferably from 53 wt % to 91 wt %, more preferably from 56 wt % to 89 wt %, still more preferably from 59 wt % to 87 wt %, particularly preferably from 61 wt % to 83 wt %, most preferably from 63 wt % to 77 wt %. When the content of the alkyl (meth)acrylate having, at an ester terminal thereof, an alkyl group having 4 to 10 carbon atoms in the monomer component (m2) falls within the ranges, the double-sided pressure-sensitive adhesive tape of the present invention can express more excellent reworkability.

The polymerizable monomers whose corresponding homopolymers each have a Tg of 0° C. or more in the monomer component (m2) may be used alone or in combination thereof.

Any appropriate polymerizable monomer whose corresponding homopolymer has a Tg of 0° C. or more may be adopted as the polymerizable monomer whose corresponding homopolymer has a Tg of 0° C. or more that may be incorporated into the monomer component (m2) to such an extent that the effect of the present invention is not impaired. Examples of such polymerizable monomer whose corresponding homopolymer has a Tg of 0° C. or more include acrylic acid, N-vinyl-2-pyrrolidone, dicyclopentanyl methacrylate, methyl methacrylate, cyclohexyl acrylate, isobornyl acrylate, β-carboxyethyl acrylate, 2-hydroxy-3-phenoxypropyl acrylate, acrylonitrile, acrylamide, dimethylacrylamide, isopropylacrylamide, hydroxyethylacrylamide, hydroxymethylacrylamide, hydroxybutylacrylamide, acryloylmorpholine, and 1-vinylimidazole. Of those, at least one kind selected from acrylic acid and N-vinyl-2-pyrrolidone is preferred because the effect of the present invention can be further expressed.

The content of the polymerizable monomer whose corresponding homopolymer has a Tg of 0° C. or more in the monomer component (m2) is preferably from 9 wt % to 47 wt %, more preferably from 11 wt % to 44 wt %, still more preferably from 13 wt % to 41 wt %, particularly preferably from 17 wt % to 39 wt %, most preferably from 23 wt % to 37 wt %. When the content of the polymerizable monomer whose corresponding homopolymer has a Tg of 0° C. or more in the monomer component (m2) falls within the ranges, the double-sided pressure-sensitive adhesive tape of the present invention can express more excellent reworkability.

Examples of the other monomer that may be incorporated into the monomer component (m2) include acryloyl group-modified compounds, such as an acryloyl group-containing silicone oil, epoxy acrylate, and urethane acrylate.

### <Cross-Linking Agent>

The amount of the cross-linking agent in the acrylic pressure-sensitive adhesive composition is preferably from 0.001 part by weight to 0.5 part by weight, more preferably from 0.005 part by weight to 0.3 part by weight, still more preferably from 0.01 part by weight to 0.2 part by weight, particularly preferably from 0.05 part by weight to 0.1 part by weight with respect to 100 parts by weight of the monomer component (m1). When the amount of the cross-linking agent with respect to 100 parts by weight of the monomer component (m1) falls within the ranges, the double-sided pressure-sensitive adhesive tape according to the embodiment of the present invention becomes more excellent in reworkability.

The cross-linking agents may be used alone or in combination thereof.

Any appropriate cross-linking agent may be adopted as the cross-linking agent to such an extent that the effect of the present invention is not impaired. A preferred example of such cross-linking agent is a polyfunctional (meth)acrylate.

Any appropriate polyfunctional (meth)acrylate may be adopted as the polyfunctional (meth)acrylate to such an extent that the effect of the present invention is not impaired. The polyfunctional (meth)acrylates may be used alone or in combination thereof. Specific examples of such polyfunctional (meth)acrylate include: ester compounds of polyhydric alcohols and (meth)acrylic acid, such as (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol penta(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, and tetramethylolmethane tri(meth)acrylate; allyl (meth)acrylate; vinyl (meth)acrylate; divinylbenzene; epoxy acrylate; polyester acrylate; urethane acrylate; butyl di(meth)acrylate; and hexyl di(meth)acrylate.

### <Photopolymerization Initiator>

Any appropriate photopolymerization initiator may be adopted as the photopolymerization initiator that may be incorporated into the acrylic pressure-sensitive adhesive composition to such an extent that the effect of the present invention is not impaired. The photopolymerization initiators may be used alone or in combination thereof. Examples of such photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, and an acylphosphine oxide-based photopolymerization initiator.

The description in the section <Acrylic Partially Polymerized Product> may be cited as it is as specific examples of the photopolymerization initiator.

The usage amount of the photopolymerization initiator is preferably from 0.001 part by weight to 0.5 part by weight, more preferably from 0.005 part by weight to 0.3 part by weight, still more preferably from 0.01 part by weight to 0.2 part by weight, particularly preferably from 0.03 part by weight to 0.1 part by weight with respect to 100 parts by weight of the monomer component (m1) from the viewpoint of, for example, the expression of satisfactory polymerizability. When the amount of the photopolymerization initiator with respect to 100 parts by weight of the monomer component (m1) falls within the ranges, the double-sided pressure-sensitive adhesive tape according to the embodiment of the present invention becomes more excellent in reworkability.

### <Acrylic Oligomer>

The acrylic pressure-sensitive adhesive composition may contain an acrylic oligomer as any other component. The weight-average molecular weight of the acrylic oligomer is preferably from 1,000 to 30,000, more preferably from 1,000 to 20,000, still more preferably from 1,500 to 10,000, particularly preferably from 2,000 to 8,000. When the acrylic pressure-sensitive adhesive composition contains the acrylic oligomer, the effect of the present invention can be further expressed. The acrylic oligomers may be used alone or in combination thereof.

The weight-average molecular weight (Mw) may be determined by a GPC method in terms of polystyrene. The weight-average molecular weight may be measured with, for example, a high-performance GPC apparatus “HPLC-8120GPC” manufactured by Tosoh Corporation under the following conditions.

### Column: TSKgel SuperHZM-H/HZ4000/HZ3000/HZ2000

### Solvent: Tetrahydrofuran

Flow rate: 0.6 ml/min

An acrylic oligomer obtained from a monomer composition containing, as an essential component, a (meth)acrylic acid ester having a cyclic structure in a molecule thereof is preferred as the acrylic oligomer, and an acrylic oligomer obtained from a monomer composition containing, as essential components, a (meth)acrylic acid ester having a cyclic structure in a molecule thereof and a (meth)acrylic acid alkyl ester having a linear or branched alkyl group is more preferred.

The (meth)acrylic acid esters each having a cyclic structure in a molecule thereof may be used alone or in combination thereof.

The (meth)acrylic acid alkyl esters each having a linear or branched alkyl group may be used alone or in combination thereof.

In the (meth)acrylic acid ester having a cyclic structure in a molecule thereof, the cyclic structure may be any one of an aromatic ring and a nonaromatic ring.

Examples of the aromatic ring include aromatic carbon rings (e.g., a monocyclic carbon ring such as a benzene ring and a fused carbon ring such as a naphthalene ring) and various aromatic heterocycles.

Examples of the nonaromatic ring include a nonaromatic aliphatic ring (nonaromatic alicyclic ring) (e.g., a cycloalkane ring, such as a cyclopentane ring, a cyclohexane ring, a cycloheptane ring, or a cyclooctane ring; or a cycloalkene ring such as a cyclohexene ring), a nonaromatic bridged ring (e.g., a bicyclic hydrocarbon ring in, for example, pinane, pinene, bornane, norbornane, or norbornene; or a tricyclic or higher aliphatic hydrocarbon ring (bridged hydrocarbon ring) in, for example, adamantane), and a nonaromatic heterocycle (e.g., an epoxy ring, an oxolane ring, or an oxetane ring). Examples of the tricyclic or higher aliphatic hydrocarbon ring (tricyclic or higher bridged hydrocarbon ring) include a dicyclopentanyl group, a dicyclopentenyl group, an adamantyl group, a tricyclopentanyl group, and a tricyclopentenyl group.

Specific examples of the (meth)acrylic acid ester having a cyclic structure in a molecule thereof include: (meth)acrylic acid cycloalkyl esters, such as cyclopentyl (meth)acrylate, cyclohexyl (meth)acrylate, cycloheptyl (meth)acrylate, and cyclooctyl (meth)acrylate; (meth)acrylic acid esters each having a bicyclic aliphatic hydrocarbon ring, such as isobornyl (meth)acrylate; (meth)acrylic acid esters each having a tricyclic or higher aliphatic hydrocarbon ring, such as dicyclopentanyl (meth)acrylate, dicyclopentanyloxyethyl (meth)acrylate, tricyclopentanyl (meth)acrylate, 1-adamantyl (meth)acrylate, 2-methyl-2-adamantyl (meth)acrylate, and 2-ethyl-2-adamantyl (meth)acrylate; and (meth)acrylic acid esters each having an aromatic ring, for example, a (meth)acrylic acid aryl ester such as phenyl (meth)acrylate, a (meth)acrylic acid aryloxyalkyl ester such as phenoxyethyl (meth)acrylate, and a (meth)acrylic acid aryl alkyl ester such as benzyl (meth)acrylate.

The (meth)acrylic acid ester having a cyclic structure in a molecule thereof is, for example, preferably a nonaromatic ring-containing (meth)acrylic acid ester, more preferably cyclohexyl acrylate (CHA), cyclohexyl methacrylate (CHMA), dicyclopentanyl acrylate (DCPA), or dicyclopentanyl methacrylate (DCPMA), still more preferably dicyclopentanyl acrylate (DCPA) or dicyclopentanyl methacrylate (DCPMA) because the effect of the present invention can be further expressed.

The content of the (meth)acrylic acid ester having a cyclic structure in a molecule thereof in all monomers that may be used for forming the acrylic oligomer is preferably from 10 parts by weight to 90 parts by weight, more preferably from 20 parts by weight to 80 parts by weight with respect to 100 parts by weight of all the monomers because the effect of the present invention can be further expressed.

Examples of the (meth)acrylic acid alkyl ester having a linear or branched alkyl group include (meth)acrylic acid alkyl esters each having an alkyl group having 1 to 20 carbon atoms, such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Of those, methyl methacrylate (MMA) is preferred because the effect of the present invention can be further expressed.

The content of the (meth)acrylic acid alkyl ester having a linear or branched alkyl group in all the monomers that may be used for forming the acrylic oligomer is preferably from 10 parts by weight to 90 parts by weight, more preferably from 20 parts by weight to 80 parts by weight, still more preferably from 20 parts by weight to 60 parts by weight with respect to 100 parts by weight of all the monomers because the effect of the present invention can be further expressed.

All the monomers (monomer composition) that may be used for forming the acrylic oligomer may contain, in addition to the (meth)acrylic acid ester having a cyclic structure in a molecule thereof and the (meth)acrylic acid alkyl ester having a linear or branched alkyl group, any other monomer (copolymerizable monomer) copolymerizable with these monomers. The content of the other monomer (copolymerizable monomer) in all the monomers (monomer composition) that may be used for forming the acrylic oligomer is preferably less than 50 parts by weight, more preferably 40 parts by weight or less, still more preferably 30 parts by weight or less, particularly preferably 20 parts by weight or less with respect to 100 parts by weight of all the monomers.

Examples of such other monomer (copolymerizable monomer) include a (meth)acrylic acid alkoxyalkyl ester (e.g., 2-methoxyethyl (meth)acrylate, 2-ethoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate, or 4-ethoxybutyl (meth)acrylate), a carboxyl group-containing monomer (e.g., (meth)acrylic acid, itaconic acid, maleic acid, fumaric acid, crotonic acid, isocrotonic acid, or an acid anhydride group-containing monomer such as maleic anhydride), a hydroxy group-containing monomer (e.g., a hydroxyalkyl (meth)acrylate, such as 2-hydroxyethyl (meth)acrylate, 3-hydroxypropyl (meth)acrylate, 4-hydroxybutyl (meth)acrylate, or 6-hydroxyhexyl (meth)acrylate; vinyl alcohol; or allyl alcohol), an amide group-containing monomer (e.g., (meth)acrylamide, N,N-dimethyl(meth)acrylamide, N-methylol(meth)acrylamide, N-methoxymethyl(meth)acrylamide, N-butoxymethyl(meth)acrylamide, or N-hydroxyethyl(meth)acrylamide), an amino group-containing monomer (e.g., aminoethyl (meth)acrylate, dimethylaminoethyl (meth)acrylate, or t-butylaminoethyl (meth)acrylate), a cyano group-containing monomer (e.g., acrylonitrile or methacrylonitrile), a sulfonic acid group-containing monomer (e.g., sodium vinylsulfonate), a phosphoric acid group-containing monomer (e.g., 2-hydroxyethylacryloyl phosphate), an isocyanate group-containing monomer (e.g., 2-methacryloyloxyethyl isocyanate), and an imide group-containing monomer (e.g., cyclohexylmaleimide or isopropylmaleimide).

All the monomers (monomer composition) that may be used for forming the acrylic oligomer particularly preferably contain: (1) at least one kind of monomer selected from dicyclopentanyl acrylate, dicyclopentanyl methacrylate, cyclohexyl acrylate, and cyclohexyl methacrylate; and (2) methyl methacrylate. In this case, the content of the monomer (1) is preferably from 30 parts by weight to 70 parts by weight with respect to 100 parts by weight of all the monomers (monomer composition) that may be used for forming the acrylic oligomer, and the content of the monomer (2) is preferably from 30 parts by weight to 70 parts by weight with respect thereto.

The acrylic oligomer may be produced by any appropriate polymerization to such an extent that the effect of the present invention is not impaired. Examples of such polymerization method include a solution polymerization method, an emulsion polymerization method, a bulk polymerization method, and a polymerization method based on active energy ray irradiation (active energy ray polymerization method). Of those, a bulk polymerization method and a solution polymerization method are preferred, and a solution polymerization method is more preferred.

A solvent that may be used in the polymerization is, for example, an organic solvent. Examples thereof include: esters, such as ethyl acetate and n-butyl acetate; aromatic hydrocarbons, such as toluene and benzene; aliphatic hydrocarbons, such as n-hexane and n-heptane; alicyclic hydrocarbons, such as cyclohexane and methylcyclohexane; and ketones, such as methyl ethyl ketone and methyl isobutyl ketone. The solvents may be used alone or in combination thereof.

In the polymerization, any appropriate polymerization initiator (e.g., a thermal polymerization initiator or a photopolymerization initiator) may be adopted to such an extent that the effect of the present invention is not impaired. The polymerization initiators may be used alone or in combination thereof. When solution polymerization is performed, an oil-soluble polymerization initiator is preferably used.

Any appropriate thermal polymerization initiator may be adopted as the thermal polymerization initiator to such an extent that the effect of the present invention is not impaired. The thermal polymerization initiators may be used alone or in combination thereof. Examples of the thermal polymerization initiator include: azo-based initiators, such as 2,2′-azobisisobutyronitrile (AIBN), 2,2′-azobis-2-methylbutyronitrile (AMBN), dimethyl 2,2′-azobis(2-methylpropionate), 4,4′-azobis-4-cyanovaleric acid, 2,2′-azobis(4-methoxy-2,4-dimethylvaleronitrile), 2,2′-azobis(2,4-dimethylvaleronitrile), 1,1′-azobis(cyclohexane-1-carbonitrile), and 2,2′-azobis(2,4,4-trimethylpentane); and peroxide-based initiators, such as benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, and 1,1-bis(t-butylperoxy)cyclododecane.

The usage amount of the thermal polymerization initiator is, for example, preferably from 0.1 part by weight to 15 parts by weight with respect to 100 parts by weight of all the monomers (monomer composition) that may be used for forming the acrylic oligomer.

Any appropriate photopolymerization initiator may be adopted as the photopolymerization initiator to such an extent that the effect of the present invention is not impaired. The photopolymerization initiators may be used alone or in combination thereof. Examples of such photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, and an acylphosphine oxide-based photopolymerization initiator.

The description in the section <Acrylic Partially Polymerized Product> may be cited as it is as specific examples of the photopolymerization initiator.

The usage amount of the photopolymerization initiator is, for example, preferably from 0.001 part by weight to 0.5 part by weight with respect to 100 parts by weight of all the monomers (monomer composition) that may be used for forming the acrylic oligomer.

At the time of the polymerization of the acrylic oligomer, a chain transfer agent may be used for adjusting its molecular weight (preferably for adjusting its weight-average molecular weight to from 1,000 to 30,000). Examples of the chain transfer agent include 2-mercaptoethanol, α-thioglycerol, 2,3-dimercapto-1-propanol, octyl mercaptan, t-nonyl mercaptan, dodecyl mercaptan (lauryl mercaptan), t-dodecyl mercaptan, glycidyl mercaptan, thioglycolic acid, methyl thioglycolate, ethyl thioglycolate, propyl thioglycolate, butyl thioglycolate, t-butyl thioglycolate, 2-ethylhexyl thioglycolate, octyl thioglycolate, isooctyl thioglycolate, decyl thioglycolate, dodecyl thioglycolate, a thioglycolic acid ester of ethylene glycol, a thioglycolic acid ester of neopentyl glycol, a thioglycolic acid ester of pentaerythritol, and an α-methylstyrene dimer. Of those, α-thioglycerol and methyl thioglycolate are preferred, and α-thioglycerol is particularly preferred from the viewpoint of, for example, the suppression of whitening of the double-sided pressure-sensitive adhesive tape of the present invention. The chain transfer agents may be used alone or in combination thereof.

The usage amount of the chain transfer agent is, for example, preferably from 0.1 part by weight to 20 parts by weight, more preferably from 0.2 part by weight to 15 parts by weight, still more preferably from 0.3 part by weight to 10 parts by weight with respect to 100 parts by weight of all the monomers (monomer composition) that may be used for forming the acrylic oligomer.

The glass transition temperature (Tg) of the acrylic oligomer is preferably from 20° C. to 300° C., more preferably from 30° C. to 300° C., still more preferably from 40° C. to 300° C.

The content of the acrylic oligomer in the acrylic pressure-sensitive adhesive composition is preferably from 0.1 part by weight to 20 parts by weight, more preferably from 0.5 part by weight to 10 parts by weight, still more preferably from 1 part by weight to 8 parts by weight, particularly preferably from 1 part by weight to 5 parts by weight with respect to 100 parts by weight of the monomer component (m1) because the effect of the present invention can be further expressed.

### <Filler>

The acrylic pressure-sensitive adhesive composition may contain a filler as any other component. The fillers may be used alone or in combination thereof.

Any appropriate filler may be adopted as the filler to such an extent that the effect of the present invention is not impaired. Examples of such filler include: metals, such as copper, silver, gold, platinum, nickel, aluminum, chromium, iron, and stainless steel; metal oxides, such as aluminum oxide, silicon oxide (silicon dioxide), titanium oxide, zirconium oxide, zinc oxide, tin oxide, copper oxide, and nickel oxide; metal hydroxides and hydrated metal compounds, such as aluminum hydroxide, boehmite, magnesium hydroxide, calcium hydroxide, zinc hydroxide, silicic acid, iron hydroxide, copper hydroxide, barium hydroxide, zirconium oxide hydrate, tin oxide hydrate, basic magnesium carbonate, hydrotalcite, dawsonite, borax, and zinc borate; carbides, such as silicon carbide, boron carbide, nitrogen carbide, and calcium carbide; nitrides, such as aluminum nitride, silicon nitride, boron nitride, and gallium nitride; carbonic acid salts such as calcium carbonate; titanic acid salts, such as barium titanate and potassium titanate; carbon-based substances, such as carbon black, a carbon tube (carbon nanotube), a carbon fiber, and diamond; inorganic materials such as glass; polymers, such as polystyrene, an acrylic resin (e.g., polymethyl methacrylate), a phenol resin, a benzoguanamine resin, a urea resin, a silicone resin, polyester, polyurethane, polyethylene (PE), polypropylene (PP), polyamide (e.g., nylon), polyimide, and polyvinylidene chloride; natural raw material particles, such as volcanic Shirasu, clay, and sand; synthetic fiber materials; and natural fiber materials. Of those, aluminum hydroxide is preferred because the effect of the present invention can be further expressed.

The content of the filler in the acrylic pressure-sensitive adhesive composition is preferably from 0.1 part by weight to 50 parts by weight, more preferably from 0.5 part by weight to 40 parts by weight, still more preferably from 1 part by weight to 30 parts by weight, particularly preferably from 5 parts by weight to 30 parts by weight, most preferably from 10 parts by weight to 20 parts by weight with respect to 100 parts by weight of the monomer component (m1) because the effect of the present invention can be further expressed.

### <Other Components>

The acrylic pressure-sensitive adhesive composition may contain any appropriate other component to such an extent that the effect of the present invention is not impaired. Examples of such other component include a tackifier, an inorganic filler, an organic filler, metal powder, a pigment, a colorant, a foil product, a softening agent, an age resistor, a conductive agent, a UV absorber, an antioxidant, a light stabilizer, a surface lubricant, a leveling agent, a corrosion inhibitor, a heat stabilizer, a polymerization inhibitor, a lubricant, a solvent, and a catalyst.

### EXAMPLES

Now, the present invention is specifically described by way of Examples. However, the present invention is by no means limited to Examples. Test and evaluation methods in Examples and the like are as described below. The term “part(s)” in the following description means “part(s) by weight” unless otherwise specified, and the term “%” in the following description means “wt %” unless otherwise specified.

<Calculation of High-Molecular Weight Polymer Content>

High-molecular weight polymer content (%)=monomer component (m1)/(monomer component (m1)+monomer component (m2)+cross-linking agent+photopolymerization initiator+acrylic oligomer)×100

### <Evaluation of Reworkability>

A reworkability test was performed by the following method. A double-sided pressure-sensitive adhesive tape cut into a size measuring 15 mm wide by 50 mm long was prepared. The pressure-sensitive adhesive layer surfaces of the double-sided pressure-sensitive adhesive tape were exposed under an environment at 23° C. and 50% RH, and one of the pressure-sensitive adhesive layer surfaces was pressure-bonded to the surface of a polycarbonate plate by one pass back and forth with a 2 kg roller. Further, the other pressure-sensitive adhesive layer surface was pressure-bonded to another polycarbonate plate by one pass back and forth with a 2 kg roller. At this time, both the surfaces of the double-sided pressure-sensitive adhesive tape each having a length of 40 mm were laminated between the two polycarbonate plates, and the portion of the double-sided pressure-sensitive adhesive tape having a length of 10 mm was brought into a state in which no layer was laminated thereon. The portion was adopted as a tab for drawing. The resultant laminate was left to stand under the environment at 23° C. and 50% RH for 30 minutes, and then the tab was drawn with a hand in the lengthwise direction of the double-sided pressure-sensitive adhesive tape. At that time, reworkability was evaluated by the following criteria.

◯: The double-sided pressure-sensitive adhesive tape was able to be peeled to the end.
x: The double-sided pressure-sensitive adhesive tape was heavy and hence could not be peeled to the end, or the tape broke during its peeling.

### <Load at Elongation of 100%>

A double-sided pressure-sensitive adhesive tape having a thickness of 150 μm was punched into a No. 1 dumbbell shape (in conformity with JIS K 6251, width: 10 mm), and was set in a tensile tester (manufactured by Shimadzu Corporation: AG-20kNG) at a chuck-to-chuck distance of 10 mm in its lengthwise direction, followed by its elongation at a tensile rate of 300 mm/min until its breakage. A load at an elongation of 100% was measured.

### <Load at Elongation of 500%>

A double-sided pressure-sensitive adhesive tape having a thickness of 150 μm was punched into a No. 1 dumbbell shape (in conformity with JIS K 6251, width: 10 mm), and was set in a tensile tester (manufactured by Shimadzu Corporation: AG-20kNG) at a chuck-to-chuck distance of 10 mm in its lengthwise direction, followed by its elongation at a tensile rate of 300 mm/min until its breakage. A load at an elongation of 500% was measured.

### <Load at Break>

A double-sided pressure-sensitive adhesive tape having a thickness of 150 μm was punched into a No. 1 dumbbell shape (in conformity with JIS K 6251, width: 10 mm), and was set in a tensile tester (manufactured by Shimadzu Corporation: AG-20kNG) at a chuck-to-chuck distance of 10 mm in its lengthwise direction, followed by its elongation at a tensile rate of 300 mm/min until its breakage. A load at break was measured.

### <Elongation at Break>

A double-sided pressure-sensitive adhesive tape having a thickness of 150 μm was punched into a No. 1 dumbbell shape (in conformity with JIS K 6251, width: 10 mm), and was set in a tensile tester (manufactured by Shimadzu Corporation: AG-20kNG) at a chuck-to-chuck distance of 10 mm in its lengthwise direction, followed by its elongation at a tensile rate of 300 mm/min until its breakage. An elongation at break was measured.

### <Tgs of Typical Monomers>

The Tgs of typical monomers to be used in Production Examples, Examples, and Comparative Examples are as described below.

### 2EHA: −70° C.

### NVP: 80° C.

### HEA: −15° C.

### BA: −54° C.

### LA: −45° C.

### AA: 106° C.

### DCPMA: 175° C.

### MMA: 105° C.

### [Production Example 1]: Synthesis of Syrup (1)

A liquid monomer mixture (monomer composition) obtained by mixing 78 parts by weight of 2-ethylhexyl acrylate (2EHA), 18 parts by weight of N-vinyl-2-pyrrolidone (NVP), and 4 parts by weight of 2-hydroxyethyl acrylate (HEA) serving as monomer components was blended with 0.05 part by weight of 2,2-dimethoxy-1,2-diphenylethan-1-one (product name: “OMNIRAD 651”, manufactured by IGM Resins B.V.) serving as a photopolymerization initiator. After that, the blend was pulse-irradiated with UV light until its viscosity (BH viscometer, No. 5 rotor, 10 rpm, measurement temperature: 30° C.) became about 15 Pas. Thus, a syrup (1) containing a partial polymer (polymerization ratio: about 8%) obtained by polymerizing part of the monomer components was obtained.

### [Production Example 2]: Synthesis of Acrylic Oligomer (1)

58 Parts by weight of dicyclopentanyl methacrylate (DCPMA), 39 parts by weight of methyl methacrylate (MMA), 3 parts by weight of α-thioglycerol, 0.2 part by weight of 2,2′-azobisisobutyronitrile, and 65 parts by weight of ethyl acetate were loaded into a flask. The flask was sufficiently filled with nitrogen, and the materials were polymerized at 70° C. for 5 hours. After that, 0.1 part by weight of 2,2′-azobisisobutyronitrile was further loaded into the flask, and the materials were polymerized at 80° C. for 8 hours. After that, ethyl acetate was evaporated from the reaction liquid, and the residue was dried with a vacuum dryer to provide an acrylic oligomer (1).

### Example 1

100 Parts by weight of the syrup (1) obtained in Production Example 1, 30 parts by weight of 2-ethylhexyl acrylate (2EHA), 15 parts by weight of acrylic acid (AA), 0.1 part by weight of 1,6-hexanediol diacrylate (HDDA) serving as a cross-linking agent, 15 parts by weight of aluminum hydroxide (manufactured by Nippon Light Metal Company, Ltd., product name: “B103”) serving as a filler, and 0.05 part by weight of 2,2-dimethoxy-1,2-diphenylethan-1-one (product name: “OMNIRAD 651”, manufactured by IGM Resins B.V.) serving as a photopolymerization initiator were blended. After that, the materials were uniformly mixed with a disper, and then the mixture was defoamed to provide an acrylic pressure-sensitive adhesive composition (1).

One surface of a polyethylene terephthalate film having a thickness of 38 μm (manufactured by Mitsubishi Chemical Corporation, product name: “MRF #38”) was subjected to release treatment with silicone, and the resultant acrylic pressure-sensitive adhesive composition (1) was applied onto the treated surface with an applicator so that its thickness became 250 μm. Thus, an applied layer was formed.

Next, one surface of a polyethylene terephthalate film having a thickness of 25 μm (manufactured by Mitsubishi Chemical Corporation, product name: “MRE #25”) was subjected to release treatment with silicone, and the film was coated with the applied layer so that its release-treated surface was on the applied layer side. Thus, oxygen was blocked. After that, UV light having an illuminance of 4 mW/cm² (measured with a UV checker “UVR-T1” manufactured by Topcon Corporation, the maximum sensitivity wavelength at the time of the measurement was about 350 nm) was applied from the upper surface of the film by using a black light lamp for 180 seconds to provide a double-sided pressure-sensitive adhesive tape (1) having a thickness of 150 μm.

The results are shown in Table 1.

### Example 2

An acrylic pressure-sensitive adhesive composition (2) and a double-sided pressure-sensitive adhesive tape (2) were obtained in the same manner as in Example 1 except that the amount of 2-ethylhexyl acrylate (2EHA) was changed to 50 parts by weight.

The results are shown in Table 1.

### Example 3

An acrylic pressure-sensitive adhesive composition (3) and a double-sided pressure-sensitive adhesive tape (3) were obtained in the same manner as in Example 2 except that the amount of acrylic acid (AA) was changed to 30 parts by weight.

The results are shown in Table 1.

### Example 4

An acrylic pressure-sensitive adhesive composition (4) and a double-sided pressure-sensitive adhesive tape (4) were obtained in the same manner as in Example 1 except that 3 parts by weight of the acrylic oligomer (1) obtained in Production Example 2 was added as a product to be blended into the acrylic pressure-sensitive adhesive composition (1).

The results are shown in Table 1.

### Example 5

An acrylic pressure-sensitive adhesive composition (5) and a double-sided pressure-sensitive adhesive tape (5) were obtained in the same manner as in Example 1 except that the amount of aluminum hydroxide (manufactured by Nippon Light Metal Company, Ltd., product name: “B103”) serving as a filler was changed to 5 parts by weight.

The results are shown in Table 1.

### Example 6

An acrylic pressure-sensitive adhesive composition (6) and a double-sided pressure-sensitive adhesive tape (6) were obtained in the same manner as in Example 1 except that 50 parts by weight of N-vinyl-2-pyrrolidone (NVP) was used instead of 15 parts by weight of acrylic acid (AA).

The results are shown in Table 1.

### Comparative Example 1

100 Parts by weight of the syrup (1) obtained in Production Example 1, 50 parts by weight of N-vinyl-2-pyrrolidone (NVP), 0.1 part by weight of 1,6-hexanediol diacrylate (HDDA) serving as a cross-linking agent, 15 parts by weight of aluminum hydroxide (manufactured by Nippon Light Metal Company, Ltd., product name: “B103”) serving as a filler, and 0.05 part by weight of 2,2-dimethoxy-1,2-diphenylethan-1-one (product name: “OMNIRAD 651”, manufactured by IGM Resins B.V.) serving as a photopolymerization initiator were blended. After that, the materials were uniformly mixed with a disper, and then the mixture was defoamed to provide an acrylic pressure-sensitive adhesive composition (C1).

A double-sided pressure-sensitive adhesive tape (C1) was obtained in the same manner as in Example 1 by using the resultant acrylic pressure-sensitive adhesive composition (C1).

The results are shown in Table 1.

### Comparative Example 2

100 Parts by weight of the syrup (1) obtained in Production Example 1, 30 parts by weight of 2-ethylhexyl acrylate (2EHA), 30 parts by weight of N-vinyl-2-pyrrolidone (NVP), 0.1 part by weight of 1,6-hexanediol diacrylate (HDDA) serving as a cross-linking agent, 15 parts by weight of aluminum hydroxide (manufactured by Nippon Light Metal Company, Ltd., product name: “B103”) serving as a filler, and 0.05 part by weight of 2,2-dimethoxy-1,2-diphenylethan-1-one (product name: “OMNIRAD 651”, manufactured by IGM Resins B.V.) serving as a photopolymerization initiator were blended. After that, the materials were uniformly mixed with a disper, and then the mixture was defoamed to provide an acrylic pressure-sensitive adhesive composition (C2).

A double-sided pressure-sensitive adhesive tape (C2) was obtained in the same manner as in Example 1 by using the resultant acrylic pressure-sensitive adhesive composition (C2).

The results are shown in Table 1.

### Comparative Example 3

100 Parts by weight of the syrup (1) obtained in Production Example 1, 50 parts by weight of lauryl acrylate (LA), 15 parts by weight of N-vinyl-2-pyrrolidone (NVP), 0.05 part by weight of 1,6-hexanediol diacrylate (HDDA) serving as a cross-linking agent, 15 parts by weight of aluminum hydroxide (manufactured by Nippon Light Metal Company, Ltd., product name: “B103”) serving as a filler, and 0.05 part by weight of 2,2-dimethoxy-1,2-diphenylethan-1-one (product name: “OMNIRAD 651”, manufactured by IGM Resins B.V.) serving as a photopolymerization initiator were blended. After that, the materials were uniformly mixed with a disper, and then the mixture was defoamed to provide an acrylic pressure-sensitive adhesive composition (C3).

A double-sided pressure-sensitive adhesive tape (C3) was obtained in the same manner as in Example 1 by using the resultant acrylic pressure-sensitive adhesive composition (C3).

The results are shown in Table 1.

### Comparative Example 4

100 Parts by weight of the syrup (1) obtained in Production Example 1, 0.05 part by weight of 1,6-hexanediol diacrylate (HDDA) serving as a cross-linking agent, 15 parts by weight of aluminum hydroxide (manufactured by Nippon Light Metal Company, Ltd., product name: “B103”) serving as a filler, and 0.05 part by weight of 2,2-dimethoxy-1,2-diphenylethan-1-one (product name: “OMNIRAD 651”, manufactured by IGM Resins B.V.) serving as a photopolymerization initiator were blended. After that, the materials were uniformly mixed with a disper, and then the mixture was defoamed to provide an acrylic pressure-sensitive adhesive composition (C4).

A double-sided pressure-sensitive adhesive tape (C4) was obtained in the same manner as in Example 1 by using the resultant acrylic pressure-sensitive adhesive composition (C4).

The results are shown in Table 1.

### Comparative Example 5

100 Parts by weight of the syrup (1) obtained in Production Example 1, 50 parts by weight of 2-ethylhexyl acrylate (2EHA), 0.1 part by weight of 1,6-hexanediol diacrylate (HDDA) serving as a cross-linking agent, 15 parts by weight of aluminum hydroxide (manufactured by Nippon Light Metal Company, Ltd., product name: “B103”) serving as a filler, and 0.05 part by weight of 2,2-dimethoxy-1,2-diphenylethan-1-one (product name: “OMNIRAD 651”, manufactured by IGM Resins B.V.) serving as a photopolymerization initiator were blended. After that, the materials were uniformly mixed with a disper, and then the mixture was defoamed to provide an acrylic pressure-sensitive adhesive composition (C5).

A double-sided pressure-sensitive adhesive tape (C5) was obtained in the same manner as in Example 1 by using the resultant acrylic pressure-sensitive adhesive composition (C5).

The results are shown in Table 1.

TABLE 1

| | | Example | Example | Example | Example | Example | Example | Comparative | Comparative | Comparative | Comparative | Comparative |
|---|---|---|---|---|---|---|---|---|---|---|---|---|
| | | 1 | 2 | 3 | 4 | 5 | 6 | Example 1 | Example 2 | Example 3 | Example 4 | Example 5 |
| Syrup | 2EHA/ | 100 | 100 | 100 | 100 | 100 | 100 | 100 | 100 | 100 | 100 | 100 |
| | NVP/ | | | | | | | | | | | |
| | HEA = | | | | | | | | | | | |
| | 78/18/4 | | | | | | | | | | | |
| | 2HEA | 30 | 50 | 50 | 30 | 30 | 30 | — | 30 | — | — | 50 |
| | LA | — | — | — | — | — | — | — | — | 50 | — | — |
| | AA | 15 | 15 | 30 | 15 | 15 | — | — | — | — | — | — |
| | NVP | — | — | — | — | — | 50 | 50 | 30 | 15 | — | — |
| Olig- | DCPMA/ | — | — | — | 3 | — | — | — | — | — | — | — |
| omer | MMA | | | | | | | | | | | |
| | 60/40 | | | | | | | | | | | |
| Cross- | HDDA | 0.1 | 0.1 | 0.1 | 0.1 | 0.1 | 0.1 | 0.1 | 0.1 | 0.05 | 0.05 | 0.1 |
| agent | TMPTA | — | — | — | — | — | — | — | — | — | — | — |
| linking | | | | | | | | | | | | |
| Filler | B103 | 15 | 15 | 15 | 15 | 5 | 15 | 15 | 15 | 15 | 15 | 15 |
| Initiator | OMNI- | 0.05 | 0.05 | 0.05 | 0.05 | 0.05 | 0.05 | 0.05 | 0.05 | 0.05 | 0.05 | 0.05 |
| | RAD | | | | | | | | | | | |
| | 651 | | | | | | | | | | | |

| | | | | | | | | | | | |
|---|---|---|---|---|---|---|---|---|---|---|---|
| Tg (° C.) | −46 | −49 | −41 | −44 | −46 | −30 | −20 | −39 | −41 | −51 | −58 |
| High-molecular | 69 | 61 | 56 | 67 | 69 | 56 | 67 | 62 | 61 | 100 | 67 |
| weight polymer | | | | | | | | | | | |
| content (%) | | | | | | | | | | | |
| Content of | 23 | 20 | 27 | 22 | 23 | 38 | 45 | 30 | 20 | 18 | 12 |
| monomer having | | | | | | | | | | | |
| Tg of 0° C. | | | | | | | | | | | |
| or more (%) | | | | | | | | | | | |
| Reworkability | ○ | ○ | ○ | ○ | ○ | ○ | x | x | x | x | x |
| Load at elongation | 2.5 | 1.0 | 5.4 | 1.9 | 2.2 | 1.6 | 10.0 | 0.7 | 0.1 | 0.01 | 0.02 |
| of 100% (N/10 mm) | | | | | | | | | | | |
| Load at elongation | 9.8 | 4.2 | 16.5 | 7.9 | 8.1 | 4.8 | 24.6 | 2.5 | 0.2 | 0.2 | 0.2 |
| of 500% (N/10 mm) | | | | | | | | | | | |
| Load at break | 18.2 | 15.2 | 29.0 | 19.2 | 19.2 | 15.5 | 28.2 | 9.1 | 0.6 | 0.4 | 0.5 |
| (N/10 mm) | | | | | | | | | | | |
| Elongation | 740 | 1,000 | 730 | 830 | 900 | 850 | 586 | 1,086 | 900 | 2,500 | 2,000 |
| at break (%) | | | | | | | | | | | |

### INDUSTRIAL APPLICABILITY

The double-sided pressure-sensitive adhesive tape of the present invention may be suitably used for, for example, the inside of a mobile device.

1. A double-sided pressure-sensitive adhesive tape, comprising an acrylic pressure-sensitive adhesive,
wherein the acrylic pressure-sensitive adhesive is formed from an acrylic pressure-sensitive adhesive composition,
wherein the double-sided pressure-sensitive adhesive tape has a load at an elongation of 100% of 7 N/10 mm or less, and
wherein the double-sided pressure-sensitive adhesive tape has a load at an elongation of 500% of 20 N/10 mm or less.

2. The double-sided pressure-sensitive adhesive tape according to claim 1, wherein the double-sided pressure-sensitive adhesive tape has a load at break of 15 N/10 mm or more.

3. The double-sided pressure-sensitive adhesive tape according to claim 1, wherein the double-sided pressure-sensitive adhesive tape has an elongation at break of 650% or more.

4. The double-sided pressure-sensitive adhesive tape according to claim 1, wherein the acrylic pressure-sensitive adhesive composition contains an acrylic oligomer.

5. The double-sided pressure-sensitive adhesive tape according to claim 1, wherein the acrylic pressure-sensitive adhesive composition contains a filler.

6. The double-sided pressure-sensitive adhesive tape according to claim 1, wherein the double-sided pressure-sensitive adhesive tape is used for an electronic device.
